(19) United States
(12) Patent Application Publication
(10) Pub. No.: US 2007/0286132 A1
(43) Pub. Date: Dec. 13, 2007

(54) Unlicensed-Licensed Interworking Enhancement Through the Implementation of an Specific Link Control Protocol Layer with Packet Prioritization

(76) Inventors: Jari Vikberg, Jarna (SE); Tomas Nylander, Varmdo (SE); Haken Niska, Linkoping (SE)

Correspondence Address: ERICSSON INC., 6300 LEGACY DRIVE, M/S EVR 1-C-11, PLANO, TX, 75024, US

(21) Appl. No.: 10/598,769

(22) PCT Filed: Mar. 12, 2004
(86) PCT No.: PCT/EP04/02614

§ 371 Date: Jul. 13, 2007

(51) Int. Cl. H04Q 7/24

(52) U.S. Cl. 370/338

(57) ABSTRACT

An unlicensed-radio access network connects a mobile station to a conventional cellular core network. The unlicensed-radio access network includes an access controller (30) connected to the core network portion and a plurality of access points (20) connected to the access controller via a broadband packet-switched network. Each access point supports an unlicensed-radio interface permitting communication between mobile stations (10) and the access controller. Both the mobile station and the access controller comprises a first link control module (15, 35) for relaying or generating packet service frames and a second transport protocol module (13, 33). In accordance with the present invention a third, link control module (14, 34) is arranged between the first and second modules for receiving packet service frames from the first link control module, determining a transmission priority assigned to each packet frame and forwarding the packet service frames to the first transport protocol module in an order corresponding to the assigned transmission priority.

### FIELD OF INVENTION

The invention relates to the transmission of packet service data, such as GPRS data via an unlicensed radio access network. The invention has particular relevance to the provision of quality of service in such an access network.

### BACKGROUND ART

Unlicensed-radio access networks provide an additional access point to cellular mobile communication systems. These access networks typically comprise an access controller connected to the core network of the cellular mobile communication systems over the conventional network interface (e.g. the A-interface and Gb interface for GSM). When viewed from the core network, this access controller appears very much like a base station subsystem of a conventional access network. The access controller is connected to a plurality of low-power unlicensed radio transceivers, or access points, each designed to establish an unlicensed radio link with a mobile station MS. Suitable unlicensed-radio formats include digital enhanced cordless telecommunications (DECT), wireless LAN and Bluetooth. An adapted mobile handset capable of operating over both the standard air interface (e.g. the Um interface) and the unlicensed-radio interface means that the subscriber requires only one phone for all environments. The access controller is connected to the access points via a broadband packet-switched network using the Internet protocol IP. A Transmission Control Protocol (TCP) connection is established between each access point and the access controller. In some cases all mobile stations connected to an access point will use the same TCP connection to the access controller. Using TCP ensures that if an IP packet is lost over either the radio or the terrestrial path (i.e. the broadband network) its loss will be acknowledged and will be retransmitted. Similarly, TCP on the receiver side ensures that a byte stream is delivered in sequential order. An unlicensed-radio access network of this kind is known from European patent application No. EP-A-1 207 708.

The General Packet Radio Service GPRS is a packet service that enables data to be sent and received across a mobile network. It is typically used to enable Internet applications such web browsing as well as file transfer but may also be used for voice-over-IP. GPRS handles a number of packet flows to a mobile station. These packet flows may have different service requirements with different priorities.

When TCP is used as the common transport mechanism for different packet flows over the unlicensed-radio access network no flow control is possible on a packet flow level. TCP implemented flow control uses common buffers for all packet flows. Accordingly if a high priority packet flow arrives at a receiving node after a low priority packet flow, the high priority flow will have to wait in the TCP buffers if a packet from the low priority flow needs re-transmitting.

There is thus a need to ensure control of packet flow across an unlicensed-radio access network irrespective of to enable the effective transport of packet services, but also of, circuit-switched user plane services, mobile station control signalling and other services requiring multiplexing, controlling and prioritising.

### SUMMARY OF THE INVENTION

The above problems are resolved in accordance with the present invention in an unlicensed access network, a mobile station and a method as defined in the appended claims.

Specifically, an unlicensed-radio access network is provided for connecting a mobile station to a core network portion of a licensed-radio mobile network. The unlicensed-radio access network includes an access controller connected to the core network portion and a broadband packet-switched network connected to the access controller. The broadband network provides a connection to a plurality of access points, each access point defining at least part of a mini-cell coverage area and supporting an unlicensed-radio interface permitting communication between mobile stations located within a respective mini-cell and the access controller. The access controller comprises a first link control relay module for relaying packet service frames and a second transport protocol module. In accordance with the present invention the access controller comprises a third, link control module arranged between the first and second modules for receiving packet service frames from the first link control relay module determining a transmission priority assigned to each packet frame and forwarding the packet service frames to the first transport protocol module in an order corresponding to the assigned transmission priority.

The provision of an additional link control module at the end point of a GPRS link over an unlicensed radio access network that is capable of rescheduling packet service frames in accordance with a desired quality of service permits different packet flow types to be supported with the optimum quality of service between a mobile station and the core network of a conventional cellular communication network. Congestion flow control can be implemented in a manner that ensures that only those services that can tolerate delays need be affected.

The transport control module preferably uses a datagram service over Internet Protocol. The datagram service can advantageously be the User Datagram Protocol (UDP).

In a particularly preferred embodiment the link control module includes a plurality of buffers for storing the packet service frames, each buffer corresponding to a specific transmission priority and being adapted to receive packet service frames of the specific transmission priority only. By sorting the packet service frames by priority the rescheduling of their transmission can be facilitated.

In a particularly advantageous embodiment of the present invention the link control module is adapted to determine an acknowledgement mode of a packet service frame and to store a packet service frame assigned an acknowledgement mode in a buffer for a period after transmission until acknowledgement said frame is received. This permits specific packet flows to be transported reliably without delaying those packet flows that require no acknowledgement, such as packet voice service.

A similar link control module is preferably provided in mobile station adapted to communicate via an unlicensed-radio access network of this type.

A still further improved quality of service can be obtained when at least one access point of the unlicensed-radio access network does not simply relay IP datagrams in a manner that is essentially transparent to both the mobile station and the access controller, but instead includes a link control relay module adapted to queue packet service frames received from a lower transport protocol module, determine a transmission priority assigned to each packet frame and forward the packet service frames to an unlicensed radio module for transmission across the unlicensed-radio interface in an order corresponding to the assigned transmission priority. This additional stage of rescheduling ensures that the assigned priority is respected across the whole link.

The full quality of service can be maintained across the link in a further preferred embodiment of the invention when the link control relay module in the access point is further adapted to determine an acknowledgement mode of a packet service frame and to assign each packet service frame to an unlicensed-radio protocol with an equivalent acknowledgement mode.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts the protocol stacks for implementing GPRS between a mobile station and an unlicensed-radio access network controller via a transparent access point in accordance with the present invention,

FIG. 2 is a block diagram schematically illustrating the function of the special link control module when passing frames from a link control layer to a datagram service layer, and

FIG. 3 is a block diagram schematically illustrating the function of the special link control module when passing frames from a datagram service layer to a link control layer, and

FIG. 4 is a block diagram schematically illustrating the function of an alternative special link control module when passing frames from a link control layer to a datagram service layer, and

FIG. 5 schematically depicts the protocol stacks for implementing GPRS between a mobile station and an unlicensed-radio access network controller via a dedicated access point in accordance with the present invention.

### DETAILED DESCRIPTION OF THE DRAWINGS

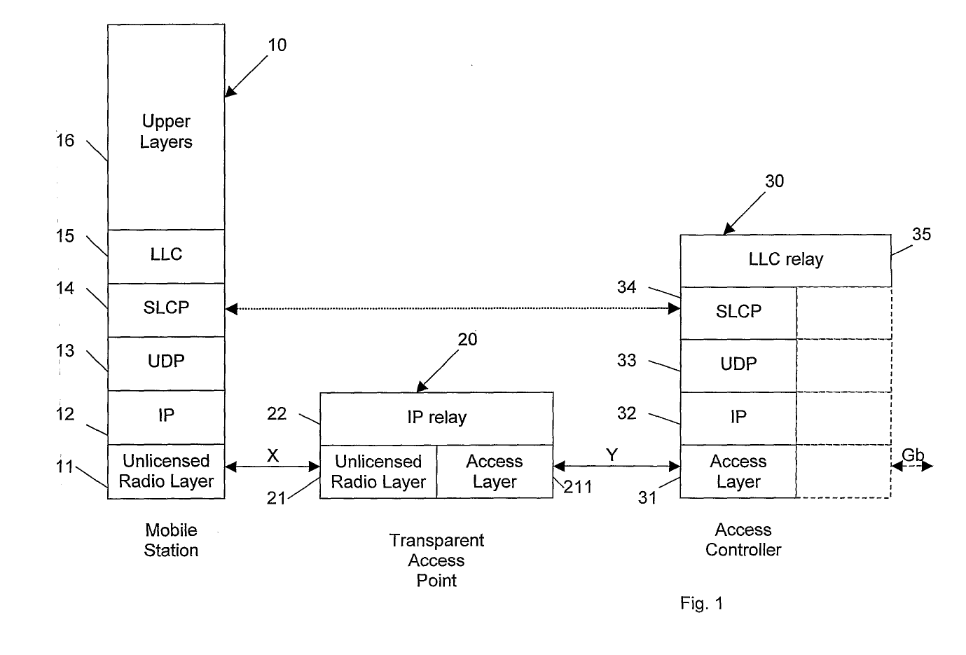

FIG. 1 schematically depicts the protocol stacks of the link between a mobile station 10 and an unlicensed radio access network for GPRS between the mobile station and a conventional mobile communications system in accordance with a first embodiment of the present invention. The unlicensed-radio access network illustrated in FIG. 1 consists of an access controller 30 and an access point 20 that is connected to the access controller 30 via a first interface, designated Y in the FIG. 1. The access controller 30 also communicates with a packet service node of the core network of a mobile communications network, which is not illustrated in the figure, over a second interface designated by a dashed arrow. This second interface corresponds to the standard interface between base station subsystems and core network packet service nodes. In the exemplary embodiment the core network is a GSM network and the interface between the access controller and the packet service node is a Gb interface.

The Y-interface between the access controller 30 and access point 20 is a packet-switched broadband network, that is typically fixed but may comprise other radio technologies. A plurality of access points are connected to, and communicate across this network with the access controller 30. Each access point 20 is able to communicate with mobile stations 10 located within a limited coverage area via an unlicensed-radio interface. Suitable unlicensed-radio formats include digital enhanced cordless telecommunications (DECT), wireless LAN and Bluetooth. The mobile station 10 is preferably capable of operating over both the standard air interface (e.g. the Um interface) and the unlicensed-radio interface so that the subscriber requires only one mobile station for all environments. In FIG. 1, however, only the protocol stack necessary for supporting GPRS communication with the unlicensed-radio access network is illustrated.

The access point 20 in the embodiment of FIG. 1 is a transparent access point when viewed both the access controller 30 and the mobile station 10. In other words, this access point relays all information at the IP level and above that is transmitted from either the mobile station 10 or the access controller. It simply effects the conversion between the OSI reference model layer 1 and 2 unlicensed-radio 21 and terrestrial access layer 211 services. Accordingly, the mobile station 10 establishes a connection with the access controller 30 without recognising the access point as a node in the connection. Similarly the access controller 30 establishes a connection with the mobile station 10 directly.

Internet protocol IP 12, 22, 32 is provided above the layer 1 and 2 services 11, 21, 211, 31 for handling the routing and forwarding of data in all three elements of the communication link shown in FIG. 1. Conventionally Transmission Control Protocol (TCP) is used between IP 12, 32 and the logical link control layer LLC 15, 35 in the mobile station 10 and access controller 30 of known unlicensed-radio access networks, as this ensures a reliable transport of IP packets by providing for acknowledgement of sent and received packets, congestion control and the sequential delivery of packets. In accordance with the present invention, however, TCP has been replaced by a datagram service, 13, 33, which in the exemplary embodiment is the User Datagram Protocol UDP. Unlike TCP, datagram services, and UDP in particular does not require handshaking to establish a connection nor does it maintain a connection state between sending and receiving nodes. For this reason UDP has no congestion or sequence control. In order to ensure the requisite reliability of the transmission of GPRS or other packet service LLC frames, therefore, an additional module with a link control protocol is provided in accordance with the present invention between the UDP layer 13 and 33 and the logical link control layer 15, 35. This additional module is referred to as the Specific Link Control Protocol SPLC 14, 34 layer.

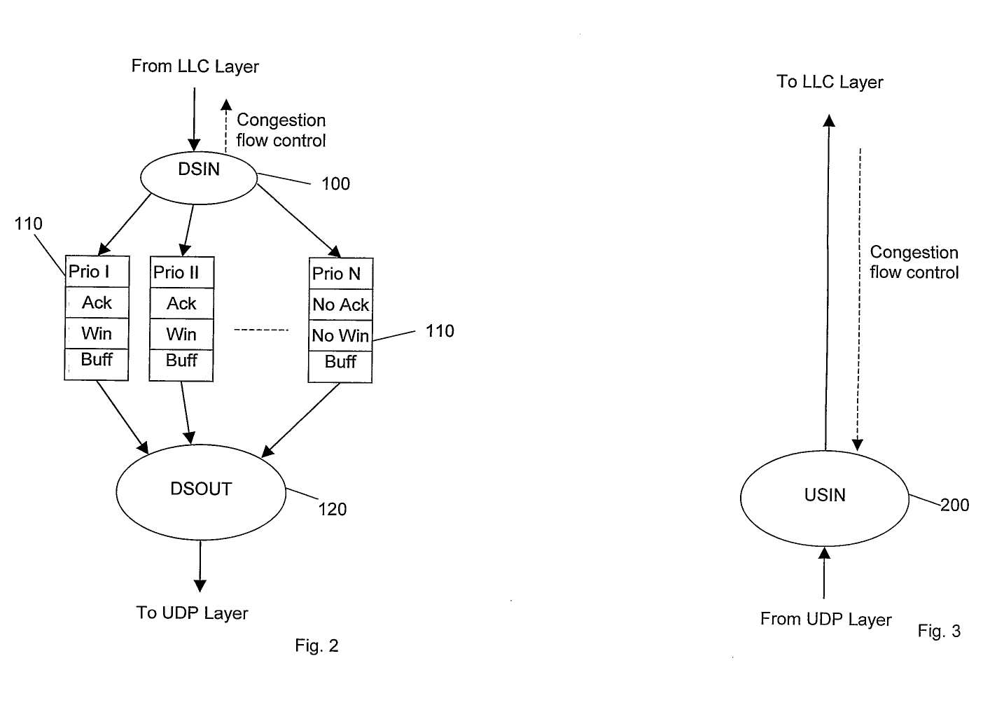

The Specific Link Control Protocol SPLC module 14, 34 is responsible for the transport of LLC frames to and from the mobile station 10 across the unlicensed-radio access network. The Specific Link Control Protocol SPLC module 14, 34 also controls priority and congestion over the link between the mobile station 10 and the access controller 30. The function of the Specific Link Control Protocol SPLC module 14, 34 will be described in more detail with reference to FIGS. 2 and 3. FIG. 2 is a block diagram schematically illustrating the function of the special link control module 14, 34 when passing LLC frames from the link control module 15 or relay layer 35 to the datagram service or UDP module 13, 33. FIG. 3 is a block diagram schematically illustrating the function of the special link control module 14, 34 when passing LLC frames in the upward direction, i.e. from the datagram service module to the link control module.

Referring now to FIG. 2, LLC frames delivered by the LLC layer module are received in the specific link control module 14, 34 by a Down Stack Input member DSIN 100, where the LLC frames are assigned to one of a plurality of LLC frame buffers 110, 1 to N LLC frame buffers are shown in FIG. 2. The LLC frame buffers 110 each have a different set of attributes corresponding to a specific quality of service. These attributes include, but are not limited to, priority (Prio 1 - Prio N), acknowledgement mode (ACK) with window size (WIN), non-acknowledgement mode (No Ack, No Win) and buffer size (Buff). At the output of the LLC frame buffers 110 is a down stack output member DSOUT 120 which serves the LLC frame buffers 110 in accordance with an appropriate algorithm to ensure that LLC frames from the highest priority buffer suffer the lowest possible delay without compromising the despatch of other packet flows.

Each LLC frame received by the specific link control protocol module SLCP 14, 34 is associated with a predetermined packet flow context that defines the quality of service expected. At activation, each packet flow is assigned to a specific LLC frame buffer 110 corresponding to the desired quality of service. The DSIN 100, upon receipt of each LLC frame from the logical link control layer 15, 35 then stores the frames in the correct LLC frame buffer 110. The DSIN 100 also checks available space in the LLC frame buffers 110 and informs the upper layer 15, 35 if congestion flow control should be applied. Congestion flow control can be applied per packet flow.

The DSOUT 120 performs the major task of the specific link control protocol module 14, 34 by serving the LLC frame buffers 110 in accordance with the selected algorithm and then implementing the various attributes associated with these buffers 110. For those LLC frames having an acknowledgement mode, the DSOUT 120 applies a window according to the defined size for acknowledgement from the receiving side. This window essentially defines the amount of outstanding unacknowledged data that the sending node can send on a particular connection before receiving an acknowledgement. This window permits the acknowledgement of arbitrary LLC frames in the window so that only non-acknowledged frames need be retransmitted. When an LLC frame in acknowledgement mode has been served by the DSOUT 120, the LLC frame is held in the buffer 110 until acknowledged by the receiving side. LLC frames in non-acknowledgement mode are simply served according to the assigned priority of the LLC frame buffer 110. These frames are removed from the buffer 110 as soon as they have been transferred by the DSOUT 120 to the UDP module 13, 33. While typically whole LLC frames will be served, LLC frame fragmentation can also be applied. SLCP control information is added to each LLC frame to indicate the assigned attributes.

Turning now to FIG. 3, the function of the specific link control protocol module 14, 34 in the opposite direction is shown. For this function there is provided an up stack input element USIN 200, which receives LLC frames from the lower UDP service module 13, 33. LLC frames in non-acknowledgement mode are simply forwarded to the upper LLC layer module 15, 35. LLC frames in acknowledgement mode are acknowledged to the sending SLCP module 14, 34 and delivered to the upper LLC layer module 15, 35. The upper layer can indicate congestion on a per packet flow level as signified by the dotted arrow in FIG. 3. If congestion is indicated the USIN discards LLC frames in non-acknowledgement mode and also refrains from acknowledging acknowledgement mode LLC frames until the upper layer indicates that congestion is terminated.

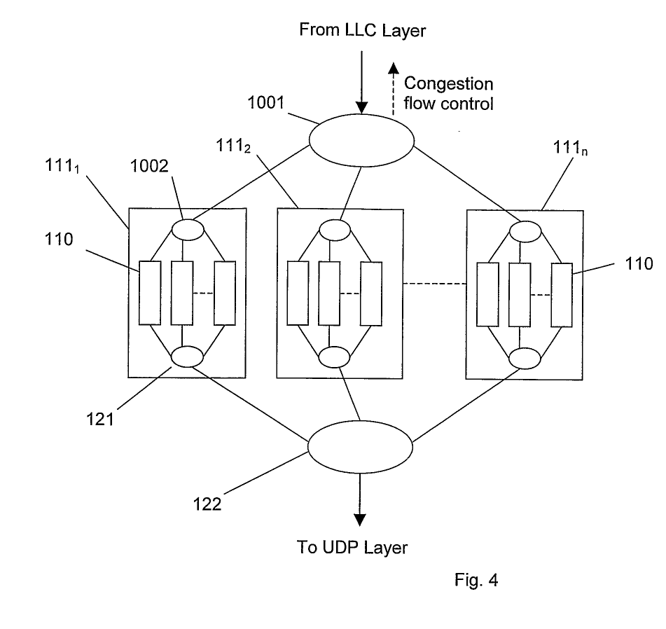

The above description of the SLCP layer module 14, 34 applies to the modules in both the access controller 30 and the mobile station 10. However, a further refinement is possible in the specific link control protocol layer SLCP module 34 of the access controller 30 that permits flow control to be exercised on a subscriber basis as well as on packet flow type. This modified SLCP module 34 function is illustrated in block diagram form in FIG. 4, which illustrates the flow direction from the upper LLC relay module 35 to the lower UDP layer module 33. The function differs from that shown in FIG. 2 essentially in that there is provided a two-stage sorting algorithm designated by the fragmented DSIN elements 1001 and 1002. The first sorting algorithm in the first DSIN element 1001 sorts LLC frames by the destination, namely the mobile station. Specifically, for each mobile station there is provided a buffer set 111ₗ to 111ₙ. Each of these buffer sets 111ₗ to 111ₙ contains a plurality of LLC frame buffers 110, which have the same attributes as those described with reference to FIG. 2 and so will not be described further here. The second DSIN elements 1002 on receiving the LLC frames from the first DSIN element 1001 assigns the LLC frames to the appropriate LLC frame buffer 110. At the output side of the buffers a two stage DSOUT function is implemented. Specifically a first DSOUT element 121 implements an algorithm to select LLC frames from the various LLC frame buffers 110 of traffic destined for an individual mobile station 10 and a further DSOUT element 122 implements an algorithm to select packets from the mobile stations 10.

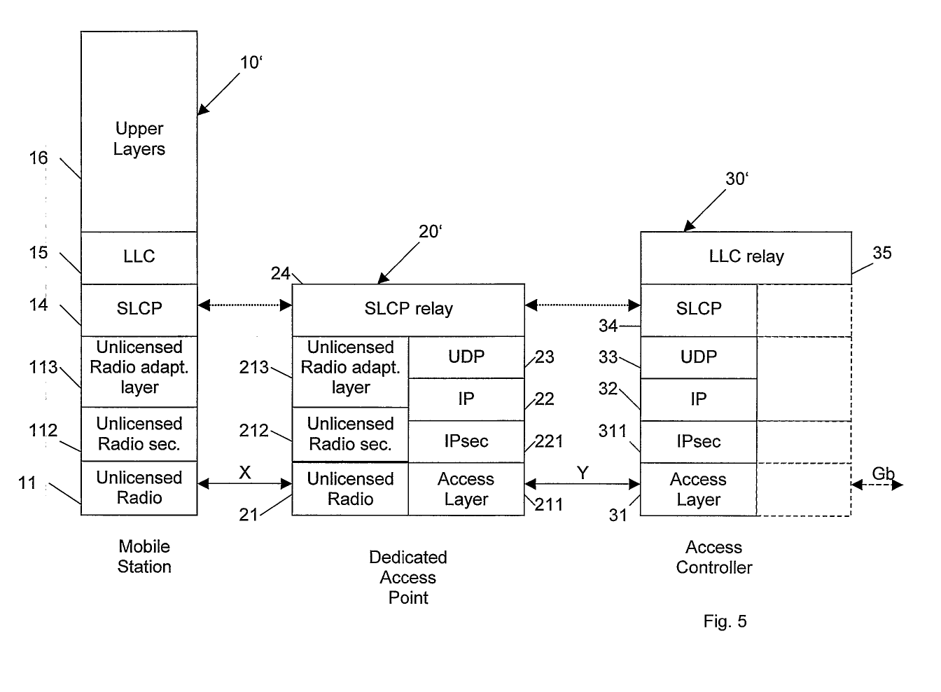

FIG. 5 schematically depicts the protocol stacks for the link between a mobile station 10 and an unlicensed radio access network for GPRS in accordance with a second embodiment of the invention. The elements illustrated in FIG. 5 include a modified mobile station 10′, a modified access point 20′ and a modified access controller 30′. In this embodiment, the access point 20′ of the unlicensed-radio access network is no longer transparent to the access controller 30′ and the mobile station 10′ but is a dedicated access point capable of communicating independently with the mobile station 10′ over the unlicensed-radio interface X or the access controller 30′ over the broadband network interface Y. This modification means that the mobile station 10′ no longer requires the IP and UDP layer modules as these are required only across the Y interface between the access point 20′ and the access controller 30′. Instead the lower layers on each side of the X interface are made up of the unlicensed-radio layer 11, 21 and an unlicensed-radio adaptation layer 113, 213. In addition there is provided an unlicensed radio security layer 112, 212 between the unlicensed-radio layer 11, 21 and the unlicensed-radio adaptation layer 113, 213. In the mobile station 10′ the specific link control protocol layer SLCP module 14 is provided above the unlicensed-radio adaptation layer 113. The function of the specific link control protocol layer SLCP module 14 in the mobile station is the same as that described above with reference to FIGS. 2 and 3. Similarly, the function of the specific link control protocol layer SLCP module 34 is unchanged over that described with reference to FIGS. 1 to 3.

The additional functionality of the dedicated access point 20′ means that available features of the unlicensed-radio interface can be exploited to improve the service. These include security options and the various transport options. This can reduce bandwidth usage and consequently increase the number of mobile stations 10′ that can be served by a single access point 20′.

In order to provide the improved security options across the whole link, there is provided an additional IP security layer 311 between the access layer 31 and IP layer 32 at the Y interface side of the access controller 30′. On the Y-interface side the dedicated access point 20′ is provided with equivalent peer layers 211, 221, 22, 23 to those provided in the access controller 30′. In addition a specific link control protocol SLCP relay module 24 is provided above the UDP layer 23 on the Y-interface and the unlicensed-radio adaptation layer 213 on the X-interface of the dedicated access point 20′.

The SLCP relay module 24 does not simply relay SLCP control information but provides an additional scheduling function. This scheduling function is also performed by the SLCP layer module 14 in the mobile station 10′ in addition to the function illustrated in FIG. 2. Specifically, an additional element is provided to assign each LLC frame to a different protocol over the radio interface according to the particular SLCP control information attributes contained in the frame. In particular, packet flows assigned as acknowledgement mode by the SLCP control information will use a protocol over the radio interface that also supports acknowledgement. Similarly those packet flows in non-acknowledgement mode will use a radio protocol without acknowledgement.

In addition to this protocol conversion function, the SLCP relay module 24 in the dedicated access node 20′ can also improves the available quality of service by reassessing the priority of packet flows. To this end LLC frames received from the UDP layer 23 are placed in queues and the SLCP control information contained therein inspected. The transmission over the radio interface can then also be rescheduled in the order of the assigned priority.

The provision of an SLCP module at the end points of a GPRS link over an unlicensed radio access network permits different packet flow types to be supported with the optimum quality of service between a mobile station and the core network of a conventional cellular communication network. For example, the following packet flow types can be assigned a decreasing level of priority with different acknowledgement modes: (1) signalling—acknowledgement mode applied, (2) voice—non-acknowledgement mode applied, (3) streaming—acknowledgement mode applied, (4) interactive—acknowledgement mode applied and (5) background—acknowledgement mode applied. Packet loss for a low priority service will not stall a higher priority service. For example, packet loss during a file transfer (background) will not affect the transmission of a video clip (streaming). Flow control can be applied to each packet flow individually. A file transfer will thus not fill up the buffers used for a video clip. Quality of service support in the transport network, i.e. differentiated services, can be used to further improve the end-to-end quality of service. In particular, the quality of service information used in the transport network, such as in IP, ethernet, VLAN etc. can be used to assign the correct priority on the SLCP layer and vice versa. Use of a dedicated access point with an SLCP relay module can still further improve the quality of service by permitting scheduling of transmission over the radio interface and selection of an appropriate protocol over the radio interface to correspond to the quality of service requirements assigned to a particular packet flow.

The invention has been described with specific reference to the implementation of GPRS transmission to a GSM core network. However, it will be understood by those skilled in the art that the above description applies equally to the transmission of a packet service in other conventional public mobile networks, such as UMTS or CDMA2000. Moreover, the improvements in quality of service are applicable not only to packet services, but also to mobile station control signalling, circuit-switched user plane services and any other service requiring multiplexing, controlling and prioritising over an unlicensed-radio access network.

1. An unlicensed-radio access network for connecting a mobile station to a core network portion of a licensed-radio mobile network, said unlicensed-radio access network comprising:
an access controller connected to said core network portion,
a broadband packet-switched network connected to said access controller;
a plurality of access points, each said access point defining at least part of a mini-cell coverage area and supporting an unlicensed-radio interface permitting communication between mobile stations located within a respective mini-cell and said access controller, wherein said access controller comprises
a first link control relay module for relaying packet service frames and
a second transport protocol module
a third link control module arranged between said first and second modules for receiving packet service frames from said first link control relay module determining a transmission priority assigned to each packet frame and forwarding said packet service frames to said first transport protocol module in an order corresponding to said assigned transmission priority.

2. The access network as claimed in claim 1, wherein said third link control module comprises a plurality of buffers for storing said packet service frames, each buffer corresponding to a specific transmission priority and being adapted to receive packet service frames of the specific transmission priority only.

3. The access network as claimed in claim 2, wherein said third link control module is further adapted to determine an acknowledgement mode of a packet service frame and to store a packet service frame assigned an acknowledgement mode in a buffer for a period after transmission until acknowledgement said frame is received.

4. The access network as claimed in claim 2, wherein said third link control module comprises multiple sets of said plurality of buffers, each set corresponding to a specific mobile station and being adapted to receive packet service frames destined for the specific mobile station only.

5. The access network as claimed in claim 1, wherein at least one access point is provided with a transport protocol module, adapted to receive packet service frames from said access controller and an unlicensed radio module for exchanging packet service frames with a mobile station over an unlicensed-radio interface, said access point further including a link control relay module adapted to
queue packet service frames received from said transport protocol module,
determine a transmission priority assigned to each packet frame and
forward said packet service frames to said unlicensed radio module in an order corresponding to said assigned transmission priority.

6. The access network as claimed in claim 5, wherein said link control relay module is further adapted to determine an acknowledgement mode of a packet service frame and to assign each packet service frame to an unlicensed-radio protocol with an equivalent acknowledgement mode.

7. The access network as claimed in claim 1 wherein said transport protocol modules provide for a datagram service over the Internet Protocol.

8. The access network as claimed in claim 7, wherein said datagram service is the User Datagram Protocol (UDP).

9. A mobile station adapted to exchange packet service frames with a core network portion of a licensed-radio mobile network via an unlicensed-radio access network, said mobile station comprising:
a first link control module for generating packet service frames and
a second unlicensed-radio module for exchanging packet service frames with an access point of said unlicensed-radio access network over an unlicensed-radio interface,
a third link control module arranged between said first and second modules for
receiving packet service frames from said first link control module
determining a transmission priority assigned to each packet frame and
forwarding said packet service frames to said second unlicensed-radio module in an order corresponding to said assigned transmission priority.

10. The mobile station as claimed in claim 9, wherein said third link control module comprises a plurality of buffers for storing said packet service frames, each buffer corresponding to a specific transmission priority and being adapted to receive packet service frames of the specific transmission priority only.

11. The mobile station as claimed claim 10, wherein said third link control module is further adapted to determine an acknowledgement mode of a packet service frame and to store a packet service frame assigned an acknowledgement mode in a buffer for a period after transmission until acknowledgement said frame is received.

12. A method in an unlicensed-radio access network for connecting a mobile station to a core network portion of a licensed-radio mobile network, said unlicensed-radio access network including
an access controller connected to said core network portion,
a broadband packet-switched network connected to said access controller and
a plurality of access points, each said access point defining a mini-cell coverage area and supporting an unlicensed-radio interface permitting communication between mobile stations located within a respective mini-cell and said access controller, wherein said access controller comprises:
a link control relay module for relaying packet service frames and
a transport protocol module
said access controller, receiving packet service frames from said link control relay module, determining a transmission priority assigned to packet frames destined for a mobile station and forwarding said packet service frames to said second transport protocol module in accordance with a first algorithm based on said assigned transmission priority.

13. The method as claimed in claim 12, further comprising the steps of:
in said access controller determining an acknowledgement mode of a packet service frame received from said link control relay module and
storing a packet service frame assigned an acknowledgement mode for a period after transmission until acknowledgement said frame is received.

14. The method as claimed in claim 12, further comprising the steps of:
in said access controller determining the destination mobile station of packet service frames received from said link control relay module and
applying a second algorithm to select among packet service frames destined for different mobile stations before applying said first algorithm.

15. The method as claimed in claim 12 further comprising the steps of:
in an access point, receiving packet service frames from said access controller, determining the assigned destination priority of said packet service frames; and
forwarding said packet service frames to a mobile station in an order defined by a third algorithm based on destination priority.

16. The method as claimed in claim 12, further comprising the steps of:
in an access point, receiving packet service frames from said access controller, determining an acknowledgement mode of a packet service frame; and
assigning each packet service frame to an unlicensed-radio protocol with an equivalent acknowledgement mode.
